(19) United States
(12) Patent Application Publication
(10) Pub. No.: US 2007/0236508 A1
(43) Pub. Date: Oct. 11, 2007

(54) Management of gridded map data regions

(75) Inventors: Duncan Lawler, Bothell, WA (US); David Buerer, Woodinville, WA (US); Nikolai Faaland, Sammamish, WA (US); Bryan Beatty, Sammamish, WA (US)

Correspondence Address: AMIN. TUROCY & CALVIN, LLP, 24TH FLOOR, NATIONAL CITY CENTER, 1900 EAST NINTH STREET, CLEVELAND, OH, 44114, US

(73) Assignee: Microsoft Corporation, Redmond, WA (US)

(21) Appl. No.: 11/391,045

(22) Filed: Mar. 28, 2006

(51) Int. Cl. G09G 5/00

(52) U.S. Cl. 345/619; 345/629

(57) ABSTRACT

A system(s) and method(s) that facilitate managing regions of a gridded map. The regions maintain independent status and functionality while interfacing with one or more other installed regions. Grids duplicated between one or more regions do not consume system resources and/or are not removed if needed by at least one installed system. Grids are not duplicated between two or more regions and regions can be independently installed and uninstalled. The installed independent regions are maintained as a single file allowing seamless viewing between regions, which is facilitated at various levels of details.

### BACKGROUND

Mobile computing devices are commonly utilized to provide users a means to communicate and stay “connected” while moving from place to place. Technology of such mobile computing devices has advanced to the point where data regarding any desired content is readily available. For example, many people utilize mapping technologies to view areas of interest, such as a hometown or a vacation spot, to obtain driving directions, or for a variety of different reasons.

There is a tremendous amount of geographic data available to the point where a user is able to “zoom in” to view an urban downtown area and then can “zoom out” to view the entire world, or a subset thereof. However, the different objects and data available are not suitable for all zooming levels. For example, a user viewing a downtown urban area might access data that contains detailed information (e.g., streets, rivers, . . . ). If that same user zooms out to a level where the entire U.S. can be seen, it is not feasible to display detailed information such as street names due to system and display constraints, as well as the tremendous amount of data available. Thus, only state names, major highways, or major cities might be detailed at such a level.

Mapping systems offer the user a means to readily view geographical data. However, these mapping systems contain all the information as one unit or one map file. As such, the entire file is one large block of data and, if a particular area or region needs to be updated, the entire file has to be replaced. In other mapping systems, the data is maintained in different files, similar to having different word processing applications open at the same time. The different files do not interact and to view data on both files, the user is constantly shifting back and forth between the files, which is not only tedious but does not present the user with a rich user experience.

In a portable mapping system, data should be readily partitioned. Storage space on such devices is generally much smaller than the size of the entire set of mapping data available. The user might often prefer to, and sometimes must, select out of all available data (e.g., the world) a subset (e.g., a city or country) to install on their device. This subset should be consistent and self-contained so that while the device is operating within the subset of data, it operates as if the entire set of map data were available. It is also desirable that the user be able to later add another subset, or remove an existing subset. For a mapping application, those subsets are defined along geographic lines, for example, many users will want their hometowns or perhaps their country of birth. These geographical subsets are referred to as “regions.”

Therefore, what is needed is to provide regions as separate files, each of which can be acquired and used independently. However, it is desirable from the application's point of view that all data is stored in one place, that there be minimal duplication of data, and that going from or viewing one region to another within the application is as seamless as possible.

### SUMMARY

The following presents a simplified summary of one or more embodiments in order to provide a basic understanding of some aspects of such embodiments. This summary is not an extensive overview of the one or more embodiments, and is intended to neither identify key or critical elements of the embodiments nor delineate the scope of such embodiments. Its sole purpose is to present some concepts of the described embodiments in a simplified form as a prelude to the more detailed description that is presented later.

In accordance with one or more embodiments and corresponding disclosure thereof, various aspects are described in connection with region management of gridded map data. According to some embodiments are a system and method for adding and removing regions from a single map file in a manner that leaves the map file in a consistent and seamless state. Having all data in a single file allows regions to be added and/or removed as needed or requested. If there is a duplication or overlap between regions, it is not reflected in the final file size. If one or more region is viewed, the application can move seamlessly from one installed region to another installed region without a user detecting the region boundaries.

To the accomplishment of the foregoing and related ends, one or more embodiments comprise the features hereinafter fully described and particularly pointed out in the claims. The following description and the annexed drawings set forth in detail certain illustrative aspects and are indicative of but a few of the various ways in which the principles of the embodiments may be employed. Other advantages and novel features will become apparent from the following detailed description when considered in conjunction with the drawings and the disclosed embodiments are intended to include all such aspects and their equivalents.

### BRIEF DESCRIPTION OF THE DRAWINGS

FIG. 1 illustrates a system that manages data regions of a gridded map.

FIG. 2 illustrates exemplary map grids.

FIG. 3 illustrates a system that adds and/or deletes gridded map data without duplicating or deleting overlapping grid data.

FIG. 4 illustrates a system that mitigates duplication between data regions of a gridded map.

FIG. 5 illustrates a system that provides seamless rendering of gridded map data.

FIG. 6 illustrates a system that employs machine learning, which facilitates automating one or more features in accordance with the one or more embodiments.

FIG. 7 illustrates a methodology for region management of gridded map data

FIG. 8 illustrates a methodology for selectively managing regions of a gridded map.

FIG. 9 illustrates a block diagram of a computer operable to execute the disclosed embodiments.

FIG. 10 illustrates a schematic block diagram of an exemplary computing environment operable to execute the disclosed embodiments.

### DETAILED DESCRIPTION

Various embodiments are now described with reference to the drawings, wherein like reference numerals are used to refer to like elements throughout. In the following description, for purposes of explanation, numerous specific details are set forth in order to provide a thorough understanding of one or more aspects. It may be evident, however, that the various embodiments may be practiced without these specific details. In other instances, well-known structures and devices are shown in block diagram form in order to facilitate describing these embodiments.

As used in this application, the terms “component, “module,” “system,” and the like are intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a server and the server can be a component. One or more components may reside within a process and/or thread of execution and a component may be localized on one computer and/or distributed between two or more computers.

The word “exemplary” is used herein to mean serving as an example, instance, or illustration. Any aspect or design described herein as “exemplary” is not necessarily to be construed as preferred or advantageous over other aspects or designs.

Furthermore, the one or more embodiments may be implemented as a method, apparatus, or article of manufacture using standard programming and/or engineering techniques to produce software, firmware, hardware, or any combination thereof to control a computer to implement the disclosed embodiments. The term “article of manufacture” (or alternatively, “computer program product”) as used herein is intended to encompass a computer program accessible from any computer-readable device, carrier, or media. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick). Additionally it should be appreciated that a carrier wave can be employed to carry computer-readable electronic data such as those used in transmitting and receiving electronic mail or in accessing a network such as the Internet or a local area network (LAN). Of course, those skilled in the art will recognize many modifications may be made to this configuration without departing from the scope or spirit of the disclosed embodiments.

Artificial intelligence based systems (e.g., explicitly and/or implicitly trained classifiers) can be employed in connection with performing inference and/or probabilistic determinations and/or statistical-based determinations as in accordance with one or more aspects as described hereinafter. As used herein, the term “inference” refers generally to the process of reasoning about or inferring states of the system, environment, and/or user from a set of observations as captured through events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources. Various classification schemes and/or systems (e.g., support vector machines, neural networks, expert systems, Bayesian belief networks, fuzzy logic, data fusion engines . . . ) can be employed in connection with performing automatic and/or inferred action in connection with the subject embodiments.

Various embodiments will be presented in terms of systems that may include a number of components, modules, and the like. It is to be understood and appreciated that the various systems may include additional components, modules, etc. and/or may not include all of the components, module etc. discussed in connection with the figures. A combination of these approaches may also be used. The various embodiments disclosed herein can be performed on electrical devices that utilize touch screen display technologies and/or mouse-and-keyboard interfaces. Examples of such devices include computers (desktop and mobile), smart phones, personal digital assistants (PDAs), and other electronic devices both wired and wireless.

In the following detailed description, various aspects and embodiments may be described in the context of a mapping system. While these inventive aspects may be well suited for use with the disclosed embodiments, those skilled in the art will readily appreciate that these inventive aspects are likewise applicable for use in various other data management systems. Accordingly, any reference to a map or mapping system is intended only to illustrate the inventive aspects, with the understanding that such inventive aspects have a wide range of applications. For example, the one or more embodiments can be applied to any data file(s) or application(s) that can be grouped together and wherein the groups can be independent from other groups and can function in conjunction with or independent from such other groups.

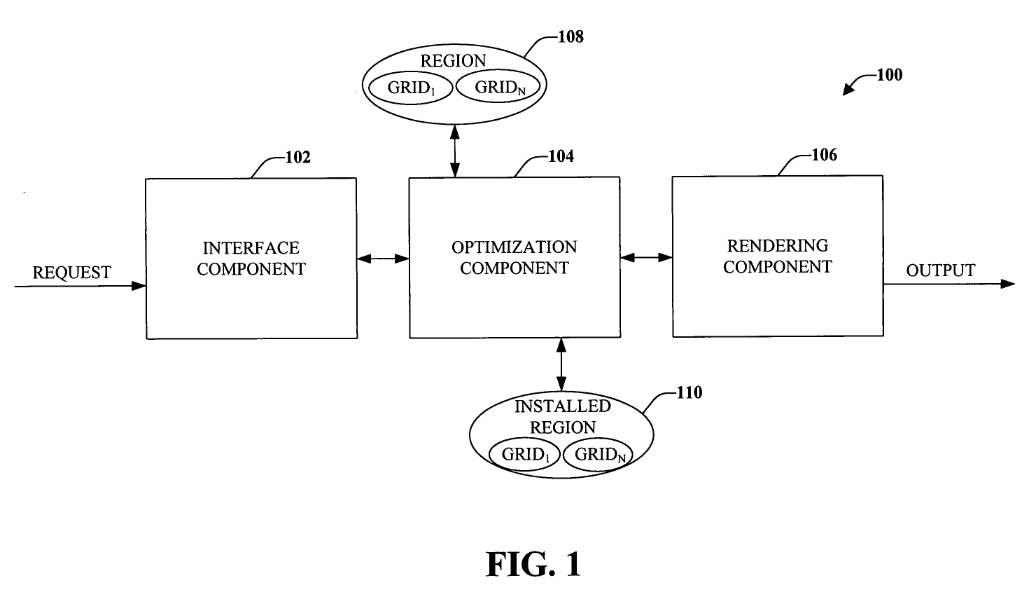

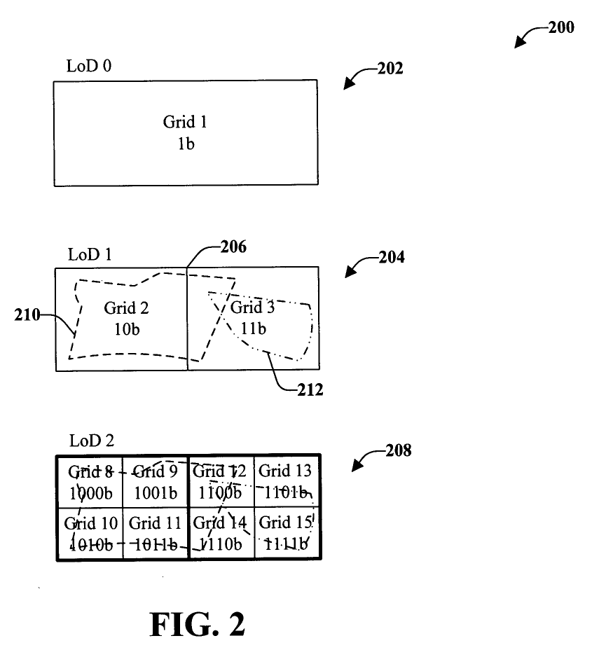

Referring initially to FIG. 1, illustrated is a system 100 that manages data regions of a gridded map. A region is a portion of a map that may be defined along geographic lines (e.g., state, city, county, . . . ). A region can include multiple grids or subsets of the region. Additional information regarding regions and grids will be described with reference to FIG. 2 below. It should be understood that while the one or more embodiments disclosed herein are discussed with reference to a geographic map, the disclosed embodiments can work equally well with other sets of data (e.g., Internet map, data file).

System 100 can be configured to enable seamless viewing of installed mapping regions that are represented by grids or blocks within those regions. System 100 can further be configured to load, add and/or remove regions, as needed, and any duplication or overlap between regions is not reflected in the final file system storage, thus, conserving system resources.

System 100 includes an interface component 102, an optimization component 104, and a rendering component 106. Interface component 102 can receive an input such as a download request, a viewing request, a deletion request, and/or other requests from a user and/or entity (e.g., the Internet, another system, a computer, . . . ). Interface component 102 can be configured to process the request and interact with optimization component 104 to provide the user and/or entity the output of the requested action through, for example, rendering component 106.

Optimization component 104 can be configured to analyze one or more parameters of a region 108 for which the user request is received. For example, a request may be to add a particular region, such as a region containing the state of Florida, to a user device. A user device may be a mobile computing device, personal digital assistant (PDA), computer, and the like. If there are no other regions 10 stored on the user device, optimization component 104 adds the entire Florida region. If however, the user device already has stored on it the region for Georgia, for example, optimization component 104 can analyze the grid identification (ID) for each grid included in the two regions. A region can include one or more grid, labeled Grid₁ through Grid_{N}, wherein N is an integer greater than or equal to zero. If both the Florida and the Georgia region contain the same grid, as determined by the grid id, the duplicate grid is not added. Thus, a duplicate of the same grid is not reflected in the final file size. Optimization component 104 can perform the same analysis if a request to add another region (e.g., Alabama, South Carolina, Tennessee, Colorado, Oregon), is received by interface component 102. If there is no duplication among regions (e.g., Alaska and Hawaii) as determined by grid IDs, the entire region is added to the user device. Other grid parameters can be analyzed by optimization component 104 to determine whether there are overlapping or duplicate grids. Such parameters can include, but are not limited to, grid ID, grid revision level, region revision level, level of detail, and/or grid type.

Optimization component 104 can further be configured to maintain each region 108 and 110 independent from each other region 108 and 110. In such a manner, each region can be installed and/or uninstalled independent of the other regions. Continuing the above example, if a request is received to delete or uninstall the Georgia region, optimization component 104 can analyze each grid ID contained in the respective regions and make a determination whether any other region installed on the user device desires a particular overlapping grid to maintain its independent and complete region. If there are grids that overlap between the Florida region and the Georgia region, optimization component will maintain the overlapping grid(s) while deleting the remaining Georgia grid(s) that are not overlapping or duplicates of the Florida grids.

Rendering component 106 can be configured to display or provide the user and/or entity with the completed request. For example, if the user is manipulating a mapping region (e.g., panning, zooming, . . . ) the displayed data can be viewed in a seamless manner whereby a user does not detect or view a transition from one installed region to another installed region. This seamless viewing can be achieved by including the various regions within a single file. The single file can be in a storage media associated with optimization component 104, or other system 100 components and/or modules. Rendering component 106 should be configured to understand or detect the divisions between grids in order to display them seamlessly, but once regions are properly inserted, rendering component 106 need not understand or detect the division between regions.

The storage media can be memory and/or some other medium that can store information. By way of illustration, and not limitation, the storage media can include nonvolatile and/or volatile memory. Suitable nonvolatile memory can include read only memory (ROM), programmable ROM (PROM), electrically programmable ROM (EPROM), electrically erasable programmable ROM (EEPROM), or flash memory. Volatile memory can include random access memory (RAM), which acts as external cache memory. By way of illustration and not limitation, RAM is available in many forms such as static RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), Rambus direct RAM (RDRAM), direct Rambus dynamic RAM (DRDRAM), and Rambus dynamic RAM (RDRAM).

It should be understood that different subsets of data and regions can be stored on different user devices. For example, User A might have Illinois and Florida installed on User A device. User B might have a large storage capacity and have the entire United States stored on User B device. User C might have only downtown Seattle stored on User C device. Thus, each user device can have different regions and subsets of those regions stored thereon.

FIG. 2 illustrates exemplary map grids 200, for example purposes. The mapping data can be represented as a gridded quaddtree, wherein grids are hierarchical. A grid can cover a rectilinear region of the world, for example, and, as the depth in the tree increases, the level of detail (LoD) represented by children grids increases. As illustrated, at the first level 202 (LoD 0), there is a single grid (Grid 1) that represents the entire mapping area (e.g., entire world). The next level 204 (LoD 1), can contain two grids (Grid 2 and Grid 3). It should be understood that while Grid 2 and Grid 3 are represented as distinct grids, there could be some overlap or duplication at the point(s) of contact 206.

At the next level 208 (LoD 2), and each subsequent level, each grid is divided into four children grids. For example, Grid 2 is divided at LoD 2 into Grid 8, Grid 9, Grid 10, and Grid 11. In a similar manner, Grid 3 is divided at LoD 2 into Grid 12, Grid 13, Grid 14, and Grid 15. It should be understood that there could be overlap or duplication between grids. For example, Grid 9 can include information that is also contained in Grids 8, 10, 11, 12, and/or 14. Such duplication or overlap allows for seamless viewing as well as simplification of dividing or separating grids or regions into logical regions, while maintaining consistency among regions (e.g., rectangular or other shape), but practically speaking, duplication is minimized.

For example purposes and not limitation, LoD 0 (Grid 1) represents the entire plant earth. At LoD 1, there are two grids (Grid 2 and Grid 3), one of which can cover the entire western hemisphere and the other the entire eastern hemisphere. Beneath this level, each grid can be square with a grid at any given level of detail having four children that are the next level of detail higher. For example, the western hemisphere grid could be divided into four grids at LoD 2, each of which covers a ninety-degree square. Each of these grids is divided into four grids at LoD 3, which cover a forty-five degree square. This continues until the last LoD is reached, such as LoD 12 or LoD 14, which may cover an area of a few city blocks.

Each grid is individually encoded and transferable and each grid can have a unique grid identification (ID). For example, Grid 1 has the grid ID “1b.” In a similar manner, the ID for Grid 2 is “10b” and the ID for grid 3 is “11b”. Similarly, the ids associated with each grid at LoD 2 (206) are Grid 8 “1000b”, Grid 9 “1001b”, Grid 10 “1010b”, Grid 11 “1011b”, Grid 12 “1100b”, Grid 13 “1101b”, Grid 14 “1110b” and Grid 15 “1111b”. It should be understood that the grid ids illustrated are examples only and other characters or means of uniquely identifying each grid can be utilized and any such modifications are intended to fall within the scope of this detailed description.

Each grid may be used independently of any other grid. Data in one grid may reference data in another grid to the extent necessary in order to present the grids seamlessly. However, the grids do not depend on each other to present the information they contain (e.g., if the references are broken the data that is present may still be used). For example, two grids may represent adjacent areas on a map. If both grids are present, the areas may be presented or used seamlessly. If one grid is missing, however, the remaining area can still be completely presented or used without loss of functionality in that area.

The following example will illustrate the concept of overlapping or duplicate grids among regions. A first region, depicted by dotted lines 210, is included in both Grid 2 and at least a portion of Grid 3, at LoD 1. A second region, depicted by dotted lines 212, is included in Grid 3 and portions overlap first region 210 or exist as part of the same space. If, at LoD 1, a request to delete region 212 is received, Grid 3 would not be deleted because region 210 is included in Grid 3 and deleting Grid 3 would remove a portion of region 210.

If however, region 210 and region 212 include data at LoD 2 (e.g., more detail is available for each region), a request to delete region 212 would be manipulated differently. At this LoD, Grid 13 and Grid 15 can be deleted or removed because there is no portion of these grids that contains region 210. This does not directly affect Grid 3 except insofar as Grid 3 may reference Grids 13 and 15. If a further level of detail (e.g., LoD 3) is available for each region (not shown), then for example, further grids (e.g., Grids 33, 41, and 43) can be removed or deleted if they do not contain any portion of region 210. If region 212 is to be added rather than deleted, a similar process occurs whereby only those grids that were not already added when region 210 was installed or loaded are added during the current operation.

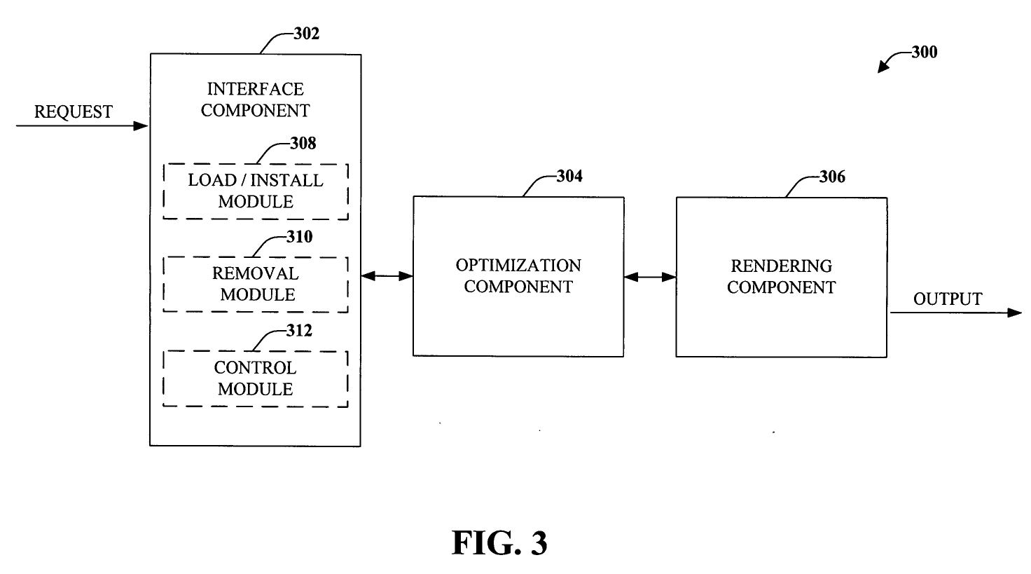

FIG. 3 illustrates a system 300 that adds and/or deletes gridded map data without duplicating or deleting overlapping grid data. Adding and/or deleting gridded map data can be referred to as region management. System 300 includes an interface component 302, an optimization component 304, and a rendering component 306.

Interface component 302 can include a load or install module 308, a removal module 310, and/or one or more control module(s) 312. Install module 308 can be configured to provide a user and/or entity a means for requesting loading and/or installing of one or more regions that contains at least one grid. If a region is to be installed, install module 308 can obtain or receive information regarding parameters of one or more grids that are included in that region. This information can be communicated to optimization component 304 for further analysis. Loading may be requested when a user and/or entity is viewing (e.g., panning, zooming, obtaining driving directions, . . . ) regions that have previously been installed or added to a user device.

For example, if there is a map displayed on a screen and the user is simply panning around looking at the map, the geometry data (a type of data the may be stored in a grid) may be loaded to provide the user with the panning or viewing functionality. If the user then requests driving directions or that a route be generated, install module 308 can obtain the requested data type (e.g., topology or connectivity data) and load that data type. Thus, rather than having each different data type loaded or running on the user device, the install module 308 (or in some embodiments optimization component 304) can selectively install only requested or needed grid types for performing particular functions, thereby conserving system resources. This can all be performed without the user being aware of region or grid organization.

Removal module 310 can be configured to operate in a manner similar to that of install module 308, however, removal module 310 can be configured to remove or delete one or more regions and/or grids associated with a region. For example, if a request to delete a region is received at interface component 302, removal module 310 can access information regarding the grid(s) included in the region as well as other regions that utilize the same grid. If another region utilizes the same grid, that grid should not be removed when the selected region for removal is deleted. Removal module 310 can supply grid information to optimization component 304.

One or more control module(s) 312 included in interface component 302 can be configured to perform various user functions. Such functions can include, but are not limited to, zooming in, zooming out, panning left, panning right (up and down), generating routes, displaying particular features in a different style, supplying viewable naming conventions of roads, buildings, rivers, countries, etc. Additionally, it may provide functions specific to regions such as add or remove a region by name or other identifying information.

Interface component 302 can be various types of user interfaces. For example, interface component 302 can provide a graphical user interface (GUI), a command line interface, and the like. For example, a GUI can be rendered that provides a user with a region or means to load, import, read, etc. data or information and can include a region to present the results of such (e.g., rendering component 306). These regions can comprise known text and/or graphic regions comprising dialogue boxes, static controls, drop-down-menus, list boxes, pop-up menus, as edit controls, combo boxes, radio buttons, check boxes, push buttons, and graphic boxes. In addition, utilities to facilitate the presentation such as vertical and/or horizontal scroll bars for navigation and toolbar buttons to determine whether a region will be viewable can be employed. For example, the user can interact with the interface component 302 by entering the information into an edit control.

The user can also interact with the regions to select and provide information through various devices such as a mouse, a roller ball, a keypad, a keyboard, a pen and/or voice activation, for example. Typically, a mechanism such as a push button or the enter key on the keyboard can be employed subsequent entering the information in order to initiate the search. However, it is to be appreciated that the disclosed embodiments are not so limited. For example, merely highlighting a check box can initiate information conveyance. In another example, a command line interface can be employed. For example, the command line interface can prompt (e.g., by a text message on a display and an audio tone) the user for information by providing a text message. The user can then provide suitable information, such as alphanumeric input corresponding to an option provided in the interface prompt or an answer to a question posed in the prompt. It is to be appreciated that the command line interface can be employed in connection with a GUI and/or API. In addition, the command line interface can be employed in connection with hardware (e.g., video cards) and/or displays (e.g., black and white, and EGA) with limited graphic support, and/or low bandwidth communication channels.

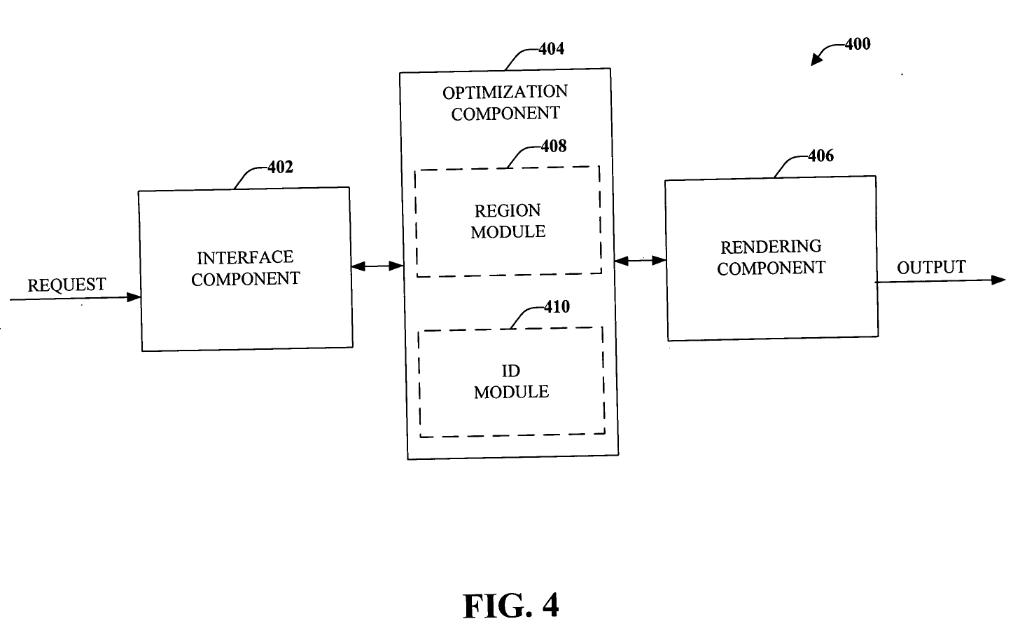

FIG. 4 illustrates a system 400 that mitigates duplication between data regions of a gridded map. System 400 is similar to the systems shown and described with reference to the above figures. Included in system 400 is an interface component 402 that can receive a region manipulation request from a user and/or entity, an optimization component 404 that can process the request, and a rendering component 406 that can present the completed request results to the user and/or entity.

Optimization component 404 can include a region module 408 and an identification (ID) module 410. Region module 408 can be configured to analyze a region and one or more grids included in the region. Regions can be selected based upon any convenient grouping of data or information.

A region can be identified by system 400 through various techniques including a numbering system, a naming convention, or other means of identifying one region from another. A user and/or entity can identify the region utilizing an easily identifiable name, such as, for example, a state name if the regions represent mapping data.

Once a region is identified or selected, ID module 410 can analyze the grids included in the region for a unique identification or other distinguishing characteristic. ID module 410 can compare the ID of grids included in the selected region with grids included in another installed region. For example, in a mapping action, a user selects the region “Oklahoma” for manipulation (e.g., viewing, adding, deleting, . . . ) and later selects the region “Arkansas” for either the same or a different manipulation. ID module 410 can analyze the grids contained in both regions and make a determination whether there are duplicate or overlapping grids between both regions. If there are duplicate grids, optimization component 404 can selectively manipulate one or more grids contained in the region to be manipulated based on the requested action. The results of the requested action can be output to the user and/or entity through rendering component 406.

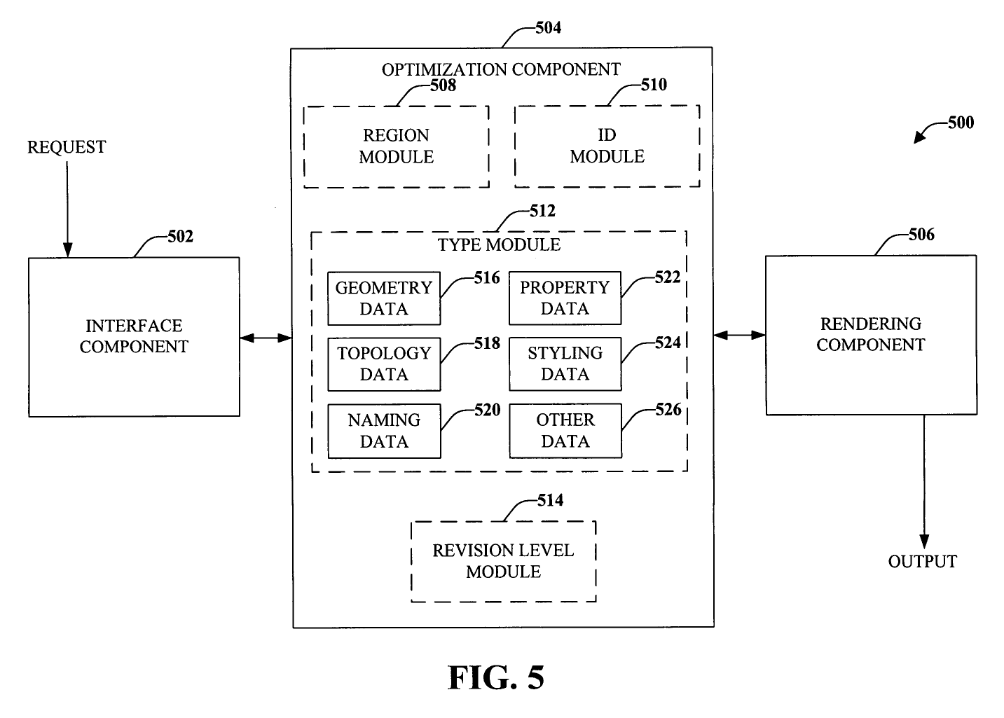

FIG. 5 illustrates a system 500 that provides seamless rendering of gridded map data. System 500 is similar to the systems shown and described with reference to the above figures and can include an interface component 502 that receives a request to manipulation a region. System 500 also includes an optimization component 504 that analyzes the region for a grid that includes a grid identification (as well as other parameters), compares the grid identification with an identification of a second grid included in an installed region, and independently manipulates the region based in part on the comparison. A rendering component 506 can be configured to output the completed manipulation request in a seamless fashion and at varying levels of detail, for example, by selecting the appropriate grids of those available to manipulate. A user and/or entity requests manipulation (e.g., viewing, adding, deleting, . . . ) of one or more regions through an interface component 502.

Optimization component 504 can be configured to selectively perform the manipulation of data while conserving system resources. Optimization component 504 can include a region module 508, an ID module 510, a type module 512, and a revision level module 514. Region module 508 can be configured to analyze a region and one or more grids included in the region. ID module 510 can be configured to analyze the grids included in the region for a unique identification or another distinguishing characteristic. System 500 can manipulate (e.g., view, add, delete, . . . ) the various data grids in a similar manner as that discussed above. Thus, system 500 can analyze the type of grid and the grid ID to ensure that the grid is not duplicated and/or deleted if necessary for another grid or region installed on a user device.

Revision level module 514 can be configured to determine a revision level between two adjacent grids. If two adjacent grids are different revision levels, revision level module 514 can make a determination whether one or more grid should be updated to a current revision level or if the existing revision level installed on the user device is appropriate for the application. Appropriate revision levels facilitate seamless viewing of map data. For example, a road might not match from point A to point B (e.g., different grids or regions) if the revision levels are not the same for the adjacent grids or regions. If certain features do not match, an update to one or more grid might correct the problem.

Type module 512 can analyze the grids and make a determination whether to manipulate the grid based in part on its type. Grid types can include geometry data 516, topology data 518, naming data 520, property data 522, styling data 524, and other types of data 526. Each type of data grid can function independently of the other types of data grids and each can be manipulated separately or in conjunction with one or more other type of data grid. Typically one or more grid types are installed together or at a similar time, however, it is possible to install each independently. For example, if a user desires to simply view a map on a screen and pan around within the map, system 500 can load the geometry data grid 516. Topology data grid 518 does not have to be loaded until the user requests a route or driving directions.

Geometry data grid 516 can store the coordinates for the vertices of lines when drawing roads, rivers, coastlines, and other items and is utilized to display the information to a user and/or entity. Topology data grid 518 can include connectivity information. For example, if a user requests driving information and either does not want to see the information in a map form (or the user device cannot support displaying mapping data), the topology data grid 518 can display the turn-by-turn directions while the geometry data grid 516 is not utilized. However, if the user desires to view the map without directions, the geometry data grid 516 can be utilized without the topology data grid 518.

By way of example and not limitation, if there are two roads “River Street” and “Mountain Avenue,” geometry data grid 516 can provide functionality to allow both roads to be drawn and/or displayed on a screen. A user viewing the roads on the screen may perceive the roads such that they cross over each other and it may appear that the roads intersect. However, if the roads are physically traveled, they might not actually intersect. It might be that one road goes over the other on an overpass and they are not connected. The roads may connect at a 4-way intersection and turns are allowed in any direction. There might be a turn restriction allowing turning left from River Street to Mountain Avenue but turning from Mountain Avenue to River Street is prohibited. This type of information is not available with only the geometry data grid 516 but can be available when the geometry data grid 516 and topology data grid 518 are utilized in conjunction.

When a user requests manipulation of the one or more regions to calculate or determine a route. Information in addition to what the geometry data grid 516 can provide should be utilized so that illegal driving directions are not provided. For example, the road speed limit can be analyzed to find the fastest route among roads that are of approximately the same length.

Naming data grid 520 can include names of various objects (e.g., states, counties, roads, rivers, . . . ). Thus, a user can simply find objects or things by a name that is distinct from the other grids. According to some embodiments, naming data grid 520 can work in conjunction with one or more other grids. Naming data grid 520 is formatted in a similar manner as the other grids are formatted. For example, a grid at LoD 10 might have all the street names for a particular city while a grid at LoD 1 contains only the names of countries and major areas of interests (e.g., states, major highways, . . . ).

It should be note that a grid at a particular level of detail is not dependent on a grid from a different level of detail. For example, removing a grid at level 2 will not affect its parent at level 1. Therefore, while a particular road may appear in both grids, the grids have completely different and independent geometry. The higher-level grid usually is simplified with fewer vertices although it may be similar to the lower level grid allowing similarity when rendering from the correct zoom level.

Property grid data 522 can include secondary information about the various objects or areas of interest (e.g., speed limits, building names, . . . ). Styling data grid 524 can be configured to display different objects or items in a different format. For example, local city streets might be shown as a thin white line while an interstate highway is shown as a double fat red line with a little shield displayed on it. Thus, styling data grid 524 provides additional attribute information that can be utilized for representing information about an object or thing.

One or more other information grids 526 can include information needed when a user and/or entity enters or types in a name or reference and can automatically zoom in to the object named (e.g., street). The information to perform this functionality can be included in blocks, which are conceptually the same as grids, however, they are not spatial items. In accordance with some embodiments, other data grid 526 can include data, such as a phone number or a URL if the object or item has a web page associated with that object or item.

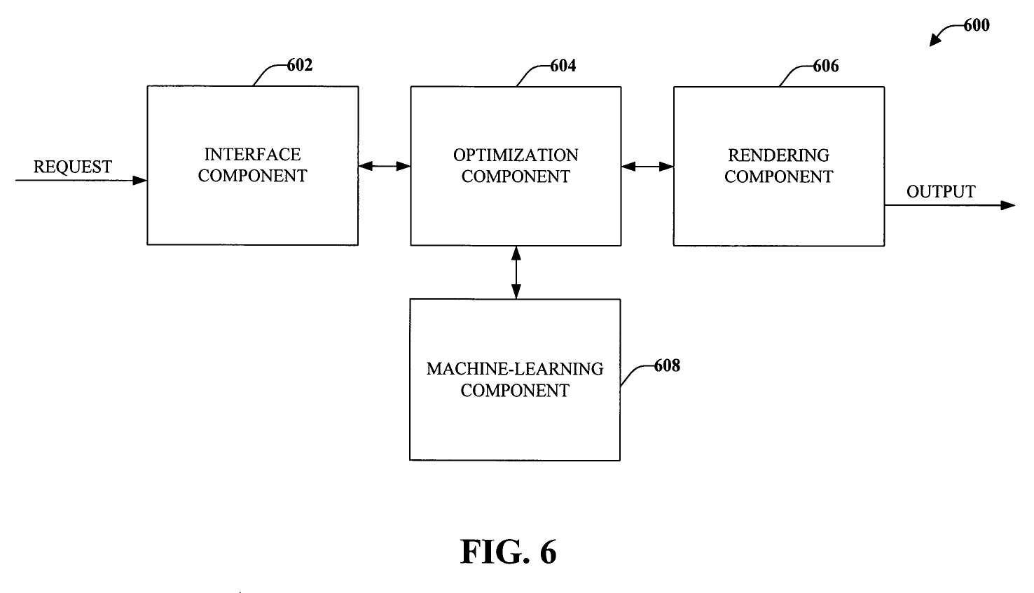

Referring now to FIG. 6 illustrated is a system 600 that employs machine learning, which facilitates automating one or more features in accordance with the one or more embodiments. The machine learning can be affected by machine-learning component 608, as illustrated.

The various embodiments (e.g., in connection with map region management) can employ various machine learning, rules-based, or artificial intelligence (AI)-based schemes for carrying out various aspects thereof. For example, a process for determining if a particular user has access to a particular grid type or if a particular grid type would be advantageous for a particular region can be facilitated through an automatic classifier system and process.

A classifier is a function that maps an input attribute vector, x=(x1, x2, x3, x4, an), to a confidence that the input belongs to a class, that is, f(x)=confidence(class). Such classification can employ a probabilistic and/or statistical-based analysis (e.g., factoring into the analysis utilities and costs) to prognoses or infer an action that a user desires to be automatically performed. In the case of mapping systems, for example, attributes can be identifying data or revision levels or other data-specific attributes derived from a grid (e.g., type, level of detail), and the classes are categories or areas of interest (e.g., region).

A support vector machine (SVM) is an example of a classifier that can be employed. The SVM operates by finding a hypersurface in the space of possible inputs, which hypersurface attempts to split the triggering criteria from the non-triggering events. Intuitively, this makes the classification correct for testing data that is near, but not identical to training data. Other directed and undirected model classification approaches include, e.g., naïve Bayes, Bayesian networks, decision trees, neural networks, fuzzy logic models, and probabilistic classification models providing different patterns of independence can be employed. Classification as used herein also is inclusive of statistical regression that is utilized to develop models of priority.

As will be readily appreciated from the subject specification, the one or more embodiments can employ classifiers that are explicitly trained (e.g., through a generic training data) as well as implicitly trained (e.g., by observing user behavior, receiving extrinsic information). For example, SVM's are configured through a learning or training phase within a classifier constructor and feature selection module. Thus, the classifier(s) can be used to automatically learn and perform a number of functions, including but not limited to determining according to a predetermined criteria when to add, delete, or load a grid, which stored grid type to execute, etc. The criteria can include, but is not limited to, the amount of data or resources to be accessed or displayed, the type of data, the level of detail to be displayed, etc.

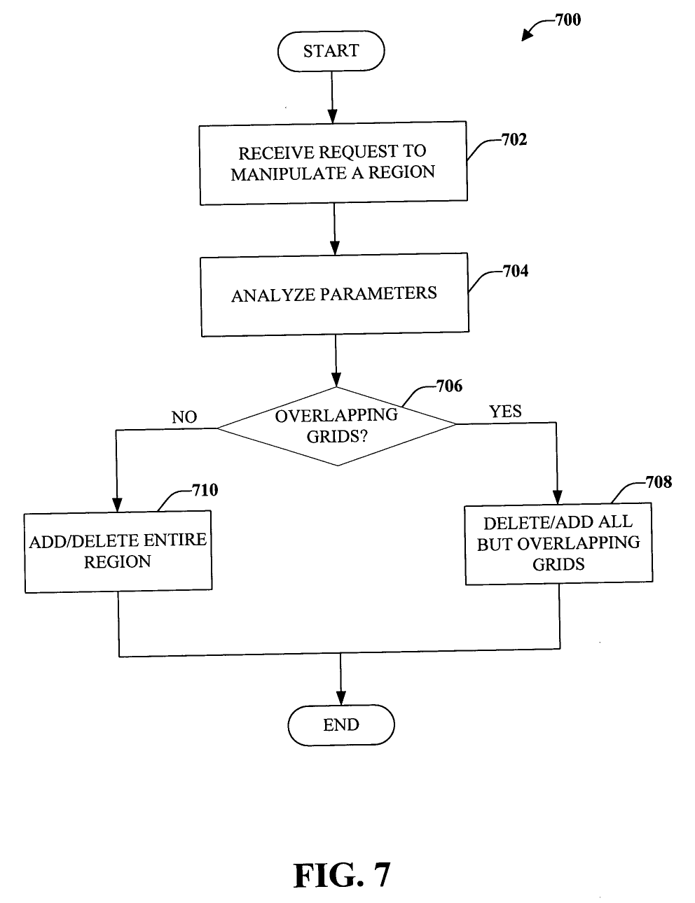

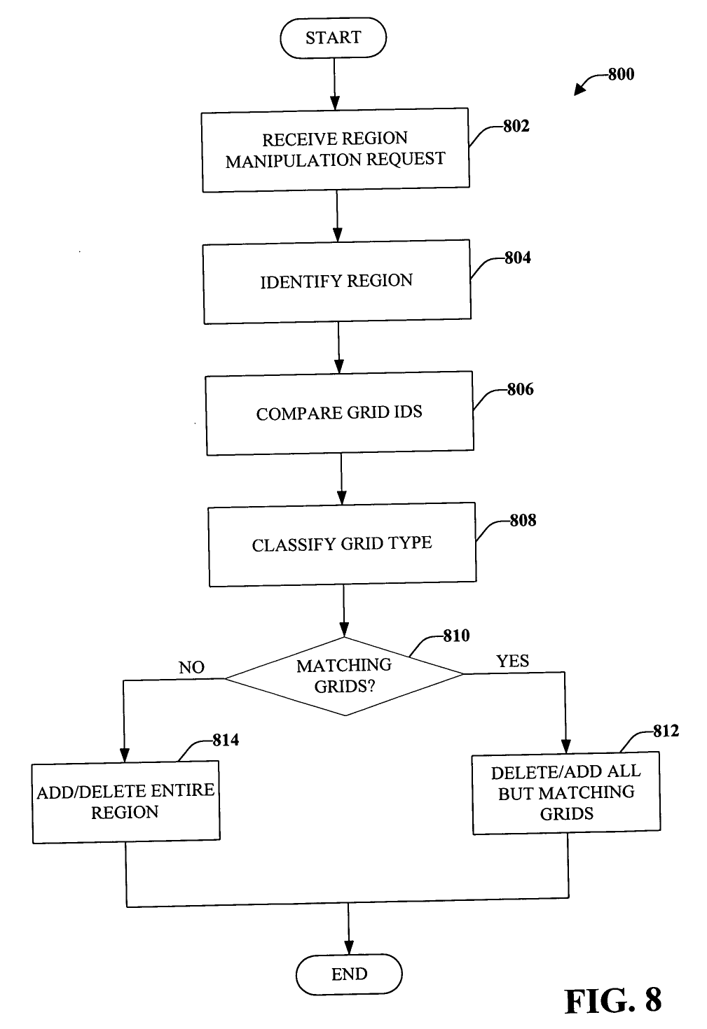

In view of the exemplary systems shown and described above, methodologies, which may be implemented in accordance with one or more aspects of the various embodiments, will be better appreciated with reference to the diagram of FIGS. 7 and 8. While, for purposes of simplicity of explanation, the methodologies are shown and described as a series of blocks, it is to be understood and appreciated that the methodologies are not limited by the order of blocks, as some blocks may, in accordance with these methodologies, occur in different orders and/or concurrently with other blocks from that shown and described herein. Moreover, not all illustrated blocks may be required to implement a methodology in accordance with one or more aspects of the disclosed embodiments. It is to be appreciated that the various blocks may be implemented by software, hardware, a combination thereof or any other suitable means (e.g. device, system, process, component) for carrying out the functionality associated with the blocks. It is also to be appreciated that the blocks are merely to illustrate certain aspects presented herein in a simplified form and that these aspects may be illustrated by a lesser and/or greater number of blocks. Moreover, not all illustrated blocks may be required to implement the following methodologies. Those skilled in the art will understand and appreciate that a methodology could alternatively be represented as a series of interrelated states or events, such as in a state diagram.

FIG. 7 illustrates a methodology 700 for region management of gridded map data. The method 700 begins at 702, when a request to manipulate a map region is received from a user and/or entity. This manipulation can include adding, deleting, viewing, etc. a particular map region that contains one or more grids or blocks of data. At 704, the one or more grids or blocks included in the region are analyzed for various parameters including a grid or block identification (ID). Other parameters can include level of detail, a grid/block type and/or a grid/block version number. Grid/block types can include, for example, geometry, topology, name, property, styling, or other data associated with a grid.

At 706, it is ascertained whether the at least one grid overlaps or is a duplicate of a grid from another region that is already installed or available. This ascertainment can be made based on whether there are overlapping or duplicate grids based in part on the grid ID. In accordance with some embodiments other parameters of the grids can be taken into consideration. For example, the grid type, revision number, level of detail, etc. can also be analyzed to ascertain whether the grids are overlapping or duplicate grids.

The one or more grids are selectively managed based in part on whether the grid overlaps a grid from the second (or other) regions. If it is ascertained at 706 that the grids overlap (“YES”) the method 700 continues at 708 where the region is deleted and/or added expect for the overlapping grid. For example, if the region is to be added, the duplicate or overlapping grid will not be added a second time. If the region is to be deleted, the duplicate or overlapping grid will not be deleted with the unduplicated grids. In such a manner, each region can be independently manipulated. If, at 706, it is ascertained that the grids are not overlapping (“NO”) the entire region is added or deleted based on the received request. When the one or more regions are displayed, the user can transition from one map region to a second map region seamlessly.

For example purposes and not limitation, a City A is defined by grids 1, 2, 3, and 4 and City B is defined by grids 3, 4, 5, and 6. When inserting one of these cities (regions) into a data file, the grids can be inserted one at a time, and if that grid ID already exists it is left alone or is not inserted. Therefore, inserting City A into a blank data file would involve inserting Grids 1, 2, 3, and 4. Subsequently inserting City B would involve inserting only Grids 5 and 6, because Grids 3 and 4 already exist. Each time a region is inserted its grid definition is remembered. After the insertion of City A and City B, the resultant map is viewable as a single consistent unit with no artifacts of the region boundaries, since the region boundaries are defined by the boundaries of the grids they contain, and the grid boundaries themselves are not visible to the application.

When removing a region, the list of grids that region defines is retrieved. The lists for other regions are also retrieved and compared such that grids that do not overlap other regions are found. The non-overlapping grids are then removed. To continue the above example, if City A is now removed, only Grids 1 and 2 are removed. When City B is removed, Grids 3, 4, 5, and 6 are removed, leaving an empty data file.

With reference now to FIG. 8, illustrated is a methodology 800 for selectively managing regions of a gridded map. At 802, a request for region manipulation is received. The manipulation request can be to view, add, and/or delete a region that represents a chunk or a portion of data. At 804, the region is identified and the grids contained in the region are verified. Each grid has a unique identifier and, at 806, this identifier is compared with identifiers of grids contained in regions previously installed. A grid type is classified with the grid identifier at 808. A grid identifier can be the same for different grid types that cover the same grid area or data. For example, grid types can be topology data, geometry data, naming conventions, property data, styling data, or other data that can provide unique attributes for a particular grid or block (chunk) of data.

The information retrieved at 804, 806, and 808 is analyzed at 810 to determine if there are matching grids between two or more regions or blocks of data. Such matching can be at the perimeters or boundaries of the regions whereby the data overlaps or is duplicated to enable seamless viewing and rendering of data as a user moves through the regions. If it is determined at 810 that there are one or more matching grids (“YES”), the method 800 continues at 812, where all but the matching grids are deleted (if a region is to be deleted) or added (if a region is to be added). If the determination at 810 is that there are no matching grids (“NO”), the method 800 continues at 814 where the entire region is added or deleted, depending on the particular manipulation request received at 802.

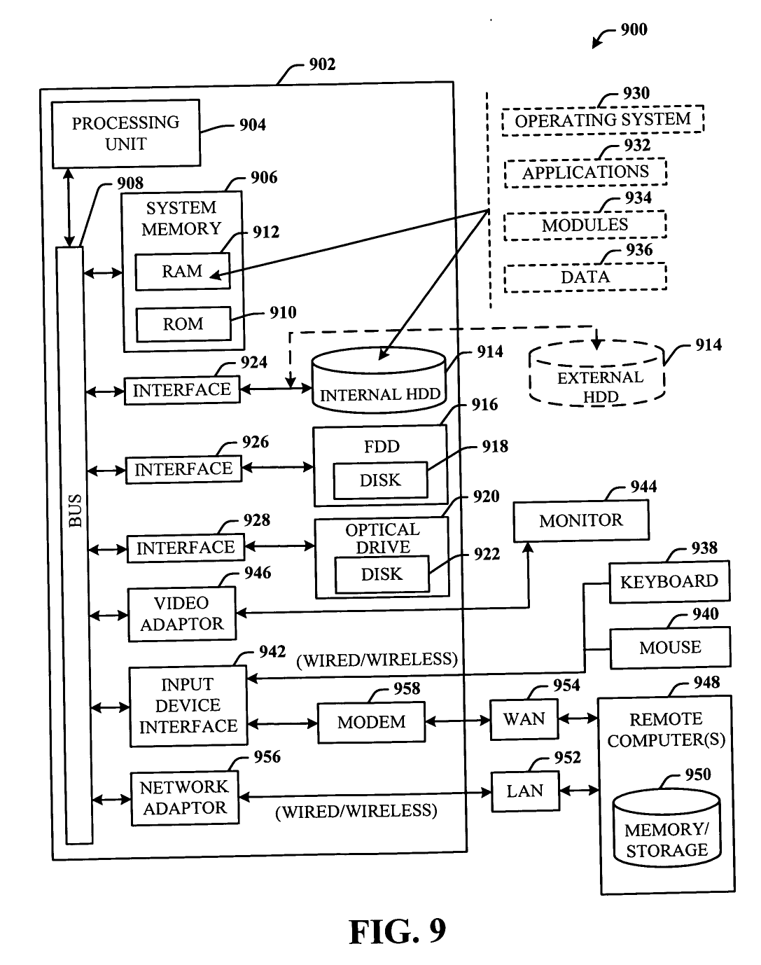

Referring now to FIG. 9, there is illustrated a block diagram of a computer operable to execute the disclosed architecture. In order to provide additional context for various aspects disclosed herein, FIG. 9 and the following discussion are intended to provide a brief, general description of a suitable computing environment 900 in which the various aspects can be implemented. While the one or more embodiments have been described above in the general context of computer-executable instructions that may run on one or more computers, those skilled in the art will recognize that the various embodiments also can be implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, as well as personal computers, hand-held computing devices, microprocessor-based or programmable consumer electronics, and the like, each of which can be operatively coupled to one or more associated devices.

The illustrated aspects may also be practiced in distributed computing environments where certain tasks are performed by remote processing devices that are linked through a communications network. In a distributed computing environment, program modules can be located in both local and remote memory storage devices.

A computer typically includes a variety of computer-readable media. Computer-readable media can be any available media that can be accessed by the computer and includes both volatile and nonvolatile media, removable and non-removable media. By way of example, and not limitation, computer-readable media can comprise computer storage media and communication media. Computer storage media includes both volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital video disk (DVD) or other optical disk storage, magnetic cassettes, magnetic tape, magnetic disk storage or other magnetic storage devices, or any other medium which can be used to store the desired information and which can be accessed by the computer.

Communication media typically embodies computer-readable instructions, data structures, program modules or other data in a modulated data signal such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

With reference again to FIG. 9, the exemplary environment 900 for implementing various aspects includes a computer 902, the computer 902 including a processing unit 904, a system memory 906 and a system bus 908. The system bus 908 couples system components including, but not limited to, the system memory 906 to the processing unit 904. The processing unit 904 can be any of various commercially available processors. Dual microprocessors and other multi-processor architectures may also be employed as the processing unit 904.

The system bus 908 can be any of several types of bus structure that may further interconnect to a memory bus (with or without a memory controller), a peripheral bus, and a local bus using any of a variety of commercially available bus architectures. The system memory 906 includes read-only memory (ROM) 910 and random access memory (RAM) 912. A basic input/output system (BIOS) is stored in a non-volatile memory 910 such as ROM, EPROM, EEPROM, which BIOS contains the basic routines that help to transfer information between elements within the computer 902, such as during start-up. The RAM 912 can also include a high-speed RAM such as static RAM for caching data.

The computer 902 further includes an internal hard disk drive (HDD) 914 (e.g., EIDE, SATA), which internal hard disk drive 914 may also be configured for external use in a suitable chassis (not shown), a magnetic floppy disk drive (FDD) 916, (e.g., to read from or write to a removable diskette 918) and an optical disk drive 920, (e.g., reading a CD-ROM disk 922 or, to read from or write to other high capacity optical media such as the DVD). The hard disk drive 914, magnetic disk drive 916 and optical disk drive 920 can be connected to the system bus 908 by a hard disk drive interface 924, a magnetic disk drive interface 926 and an optical drive interface 928, respectively. The interface 924 for external drive implementations includes at least one or both of Universal Serial Bus (USB) and IEEE 1394 interface technologies. Other external drive connection technologies are within contemplation of the one or more embodiments.

The drives and their associated computer-readable media provide nonvolatile storage of data, data structures, computer-executable instructions, and so forth. For the computer 902, the drives and media accommodate the storage of any data in a suitable digital format. Although the description of computer-readable media above refers to a HDD, a removable magnetic diskette, and a removable optical media such as a CD or DVD, it should be appreciated by those skilled in the art that other types of media which are readable by a computer, such as zip drives, magnetic cassettes, flash memory cards, cartridges, and the like, may also be used in the exemplary operating environment, and further, that any such media may contain computer-executable instructions for performing the methods disclosed herein.

A number of program modules can be stored in the drives and RAM 912, including an operating system 930, one or more application programs 932, other program modules 934 and program data 936. All or portions of the operating system, applications, modules, and/or data can also be cached in the RAM 912. It is appreciated that the various embodiments can be implemented with various commercially available operating systems or combinations of operating systems.

A user can enter commands and information into the computer 902 through one or more wired/wireless input devices, e.g., a keyboard 938 and a pointing device, such as a mouse 940. Other input devices (not shown) may include a microphone, an IR remote control, a joystick, a game pad, a stylus pen, touch screen, or the like. These and other input devices are often connected to the processing unit 904 through an input device interface 942 that is coupled to the system bus 908, but can be connected by other interfaces, such as a parallel port, an IEEE 1394 serial port, a game port, a USB port, an IR interface, etc.

A monitor 944 or other type of display device is also connected to the system bus 908 through an interface, such as a video adapter 946. In addition to the monitor 944, a computer typically includes other peripheral output devices (not shown), such as speakers, printers, etc.

The computer 902 may operate in a networked environment using logical connections through wired and/or wireless communications to one or more remote computers, such as a remote computer(s) 948. The remote computer(s) 948 can be a workstation, a server computer, a router, a personal computer, portable computer, microprocessor-based entertainment appliance, a peer device or other common network node, and typically includes many or all of the elements described relative to the computer 902, although, for purposes of brevity, only a memory/storage device 950 is illustrated. The logical connections depicted include wired/wireless connectivity to a local area network (LAN) 952 and/or larger networks, e.g., a wide area network (WAN) 954. Such LAN and WAN networking environments are commonplace in offices and companies, and facilitate enterprise-wide computer networks, such as intranets, all of which may connect to a global communications network, e.g., the Internet.

When used in a LAN networking environment, the computer 902 is connected to the local network 952 through a wired and/or wireless communication network interface or adapter 956. The adaptor 956 may facilitate wired or wireless communication to the LAN 952, which may also include a wireless access point disposed thereon for communicating with the wireless adaptor 956.

When used in a WAN networking environment, the computer 902 can include a modem 958, or is connected to a communications server on the WAN 954, or has other means for establishing communications over the WAN 954, such as by way of the Internet. The modem 958, which can be internal or external and a wired or wireless device, is connected to the system bus 908 through the serial port interface 942. In a networked environment, program modules depicted relative to the computer 902, or portions thereof, can be stored in the remote memory/storage device 950. It will be appreciated that the network connections shown are exemplary and other means of establishing a communications link between the computers can be used.

The computer 902 is operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This includes at least Wi-Fi and Bluetooth™ wireless technologies. Thus, the communication can be a predefined structure as with a conventional network or simply an ad hoc communication between at least two devices.

Wi-Fi, or Wireless Fidelity, allows connection to the Internet from a couch at home, a bed in a hotel room, or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11(a, b, g, etc.) to provide secure, reliable, fast wireless connectivity. A Wi-Fi network can be used to connect computers to each other, to the Internet, and to wired networks (which use IEEE 802.3 or Ethernet). Wi-Fi networks operate in the unlicensed 2.4 and 5 GHz radio bands, at an 11 Mbps (802.11a) or 54 Mbps (802.11b) data rate, for example, or with products that contain both bands (dual band), so the networks can provide real-world performance similar to the basic 10BaseT wired Ethernet networks used in many offices.

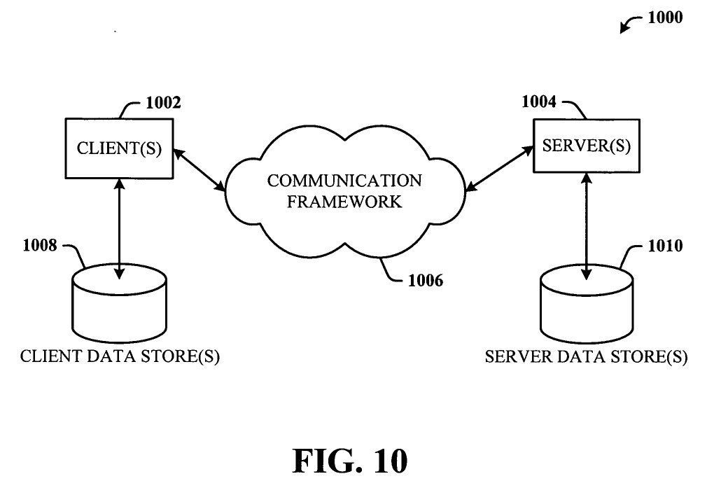

Referring now to FIG. 10, there is illustrated a schematic block diagram of an exemplary computing environment 1000 in accordance with the various embodiments. The system 1000 includes one or more client(s) 1002. The client(s) 1002 can be hardware and/or software (e.g., threads, processes, computing devices). The client(s) 1002 can house cookie(s) and/or associated contextual information by employing the various embodiments, for example.

The system 1000 also includes one or more server(s) 1004. The server(s) 1004 can also be hardware and/or software (e.g., threads, processes, computing devices). The servers 1004 can house threads to perform transformations by employing the various embodiments, for example. One possible communication between a client 1002 and a server 1004 can be in the form of a data packet adapted to be transmitted between two or more computer processes. The data packet may include a cookie and/or associated contextual information, for example. The system 1000 includes a communication framework 1006 (e.g., a global communication network such as the Internet) that can be employed to facilitate communications between the client(s) 1002 and the server(s) 1004.

Communications can be facilitated through a wired (including optical fiber) and/or wireless technology. The client(s) 1002 are operatively connected to one or more client data store(s) 1008 that can be employed to store information local to the client(s) 1002 (e.g., cookie(s) and/or associated contextual information). Similarly, the server(s) 1004 are operatively connected to one or more server data store(s) 1010 that can be employed to store information local to the servers 1004.

What has been described above includes examples of the various embodiments. It is, of course, not possible to describe every conceivable combination of components or methodologies for purposes of describing the various embodiments, but one of ordinary skill in the art may recognize that many further combinations and permutations are possible. Accordingly, the subject specification intended to embrace all such alterations, modifications, and variations that fall within the spirit and scope of the appended claims.

In particular and in regard to the various functions performed by the above described components, devices, circuits, systems and the like, the terms (including a reference to a “means”) used to describe such components are intended to correspond, unless otherwise indicated, to any component which performs the specified function of the described component (e.g., a functional equivalent), even though not structurally equivalent to the disclosed structure, which performs the function in the herein illustrated exemplary aspects. In this regard, it will also be recognized that the various aspects include a system as well as a computer-readable medium having computer-executable instructions for performing the acts and/or events of the various methods.

In addition, while a particular feature may have been disclosed with respect to only one of several implementations, such feature may be combined with one or more other features of the other implementations as may be desired and advantageous for any given or particular application. Furthermore, to the extent that the terms “includes,” and “including” and variants thereof are used in either the detailed description or the claims, these terms are intended to be inclusive in a manner similar to the term “comprising.”

What is claimed is:

1. A system that facilitates region management of map data, comprising:
an interface component that receives a request to manipulation a region;
an optimization component that analyzes the region for a grid that includes a grid identification, compares the grid identification with an identification of a second grid included in an installed region, and independently manipulates the region based in part on the comparison; and
a rendering component that outputs the completed manipulation request in a seamless fashion.

2. The system of claim 1, the optimization component further analyzes the grid for a grid type and selectively manipulates a subset of the region based on the grid identification and the grid type.

3. The system of claim 2, the grid type is one of a geometry, a topology, a naming, a property, and a styling.

4. The system of claim 1, the manipulation request is one of a region view, a region addition, and a region deletion.

5. The system of claim 1, the optimization component further maintains the region and the installed region in one data file.

6. The system of claim 1, each grid is independently encoded and transferable.

7. The system of claim 1, the rendering component displays the grid information at varying levels of detail.

8. The system of claim 1, the optimization component selectively adds grids of a region if the grids are not already included in the installed region.

9. The system of claim 1, the optimization component selectively deletes one or more grids of a region if the grids are not utilized by the installed region.

10. The system of claim 1, the optimization component selectively manipulates the grid and the grid included in the installed region to conserve system resources.

11. The system of claim 1, further comprising a level of detail module that selectively analyzes a lower level grid for at least one duplicate lower level grid.

12. The system of claim 1, further comprising a machine learning component that automatically analyzes and manipulates the region and the installed region.

13. A method of region management for gridded map data, comprising:
receiving a request to manipulate a first map region;
analyzing a grid identification of at least one grid included in the first map region;
ascertaining whether the at least one grid overlaps a grid from a second map region based in part on the analyzed grid identification; and
selectively managing the at least one grid based on whether the grid overlaps the grid from the second map region.

14. The method of claim 13, selectively managing the at least one grid further comprising inserting the at least one grid if it does not overlap the grid from the second map region.

15. The method of claim 13, selectively managing the at least one grid further comprising deleting the at least one grid if it does not overlap the grid from the second map region.

16. The method of claim 13, further comprising:
displaying the first map region and the second region; and
seamlessly switching between the first map region and the second map region when a request to transition from the map region to the second map region is received.

17. The method of claim 13, receiving a request to manipulate a first map region is one of a viewing request, a deletion request, and an addition request.

18. The system of claim 13, further comprising maintaining one or more region in a single data file.

19. A computer executable system that provides management of gridded map data, comprising
computer implemented means for comparing at least two map regions;
computer implemented means for identifying at least one grid common to the at least two map regions; and
computer implemented means for independently altering one of the at least two map regions based on the at least one common grid to conserve system resources.

20. The computer executable system of claim 19, further comprising computer implemented means for displaying the result of the alteration of the at least two map regions in a seamless manner.
